(19) United States
(12) Patent Application Publication
(10) Pub. No.: US 2020/0001122 A1
(43) Pub. Date: Jan. 2, 2020

(54) Safety Device

(71) Applicant: Jim Patlan, Fresno, CA (US)

(72) Inventor: Jim Patlan, Fresno, CA (US)

(21) Appl. No.: 16/380,607

(22) Filed: Apr. 10, 2019

Related U.S. Application Data
(60) Provisional application No. 62/693,014, filed on Jul. 2, 2018.

(51) Int. Cl. A62B 3/00; B26B 11/00; B25F 1/00; B60R 22/32

(52) U.S. Cl. CPC A62B 3/005; B26B 11/00; B60R 2022/328; B60R 22/32; B25F 1/006

(57) ABSTRACT

A safety device with a blade for severing a seatbelt during an emergency. The blade is movably affixed to a blade bar of the safety device, such that the blade can slide along a width of the seatbelt to cut through the seatbelt during an emergency. The safety device includes a housing configured to protect an individual from the blade when the safety device is not in use. The safety device is useful for escaping emergencies, such as automobile collisions and the like.

### CROSS REFERENCE TO RELATED APPLICATIONS

This application claims the benefit of U.S. Provisional Application No. 62/693,014 filed on Jul. 2, 2018. The above identified patent application is herein incorporated by reference in its entirety to provide continuity of disclosure.

### BACKGROUND OF THE INVENTION

In a vehicle accident, an individual may become trapped inside a vehicle. An individual may be required to quickly escape the vehicle due to an emergency, such as an engine fire. Sometimes, the individual may be trapped inside the vehicle due to a seatbelt jam, and the individual may not have a knife or sharp object to cut the seatbelt to escape the vehicle. In addition, in some emergencies, a vehicle door may be jammed, requiring the individual to shatter a window to escape the vehicle. Accordingly, a device that provides a blade configured to cut through a seatbelt and a glass breaker configured to shatter a vehicle window is desired.

Consequently, there is a need for an improved safety device. The present invention substantially diverges in design elements from the known art, and solves a problem often faced during an emergency. The present invention substantially fulfills these needs.

### SUMMARY OF THE INVENTION

The present invention provides a safety device wherein the same can be utilized for providing added protection for an individual in an emergency situation. The safety device includes a blade mechanism movably affixed to a blade bar, such that a strap placed through the safety device may be cut by the blade when the blade is slid across the blade bar.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings, wherein like numeral annotations are provided throughout.

FIG. 1 shows a perspective view of an embodiment of a safety device attached to a strap while being worn by an individual.

FIG. 2A shows a front view of an embodiment of the base plate with the strap extending across an inside portion.

FIG. 2B shows a front view of an embodiment of the base plate where the blade is in a cutting position.

FIG. 3 shows a front view of an embodiment of the device with the cover attached and the device with the cover removed.

FIG. 4A shows a bottom up view an embodiment of the device with a pressure clip attachment to hold the blade in place.

FIG. 4B shows a side view of an embodiment of the blade structure separated from the base plate.

FIG. 5 shows a prospective view of an embodiment of an embodiment attached to a car seat belt strap.

FIG. 6 shows a close up view of an embodiment where a class breaker is attached to an outside edge of the cover.

### DETAILED DESCRIPTION OF THE INVENTION

Reference is made herein to the attached drawings. Like reference numerals are used throughout the drawings to depict like or similar elements of the safety device. For the purposes of presenting a brief and clear description of the present invention, a preferred embodiment will be discussed as used for a safety device attached to a car seat belt strap. The figures are intended for representative purposes only and should not be considered to be limiting in any respect.

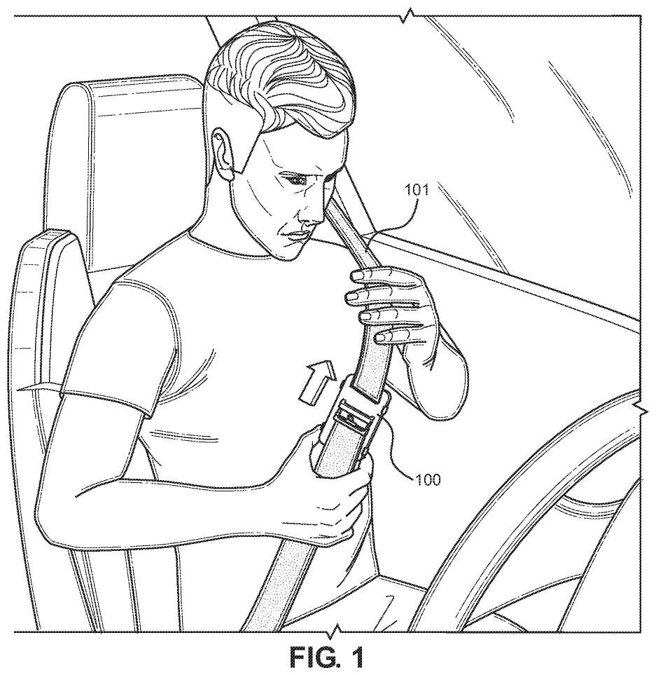

Referring now to FIG. 1, there is shown a perspective view of an embodiment of a safety device attached to a strap while being worn by an individual. In the pictured embodiment the device 100 is attached to a car seat belt strap 101. The device can be made out of, but is not limited to, a hard plastic or a light weight metal. The hard plastic may be shock resistant such that it will not break when hitting a window. This will allow the device to remain in a useable condition after an accident. If the device is made from a metal, it may be strong enough to not allow the device to bend on impacts.

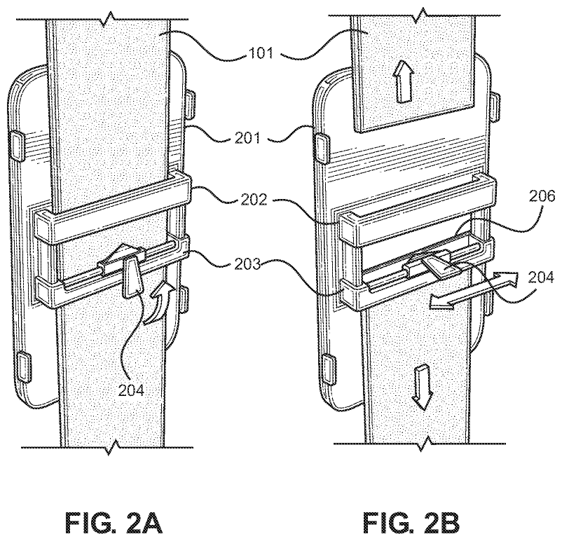

Referring now to FIG. 2A and 2B, the strap 101 can be seen running across the inside portion of the base plate 201. In this embodiment a blade structure 202 can be seen attached to the base plate 201. This blade structure 202 has a first opening and a second opening to allow for the strap 101 to pass through it. This ensures the safety belt will remain in the appropriate position to be cut in the event of an emergency.

In FIG. 2A there can be seen a blade 207 attached to the blade handle 208. The blade 207 may be in a triangle shape with sharp edges on both sides. This ensures that the blade can be moved back and forth over the belt and cut all the way through the belt. In this embodiment there is also a blade bar 203 attached to the blade structure 202. The blade bar 203 runs across the strap 101. The blade 207 may be kept in a storage position, in the shown embodiment the storage position will be flipped up away from the safety belt 101. In this position the blade 207 will not cut through the belt 101.

In FIG. 2B there is shown a top down view with a portion of the belt removed. In this view the blade is moved from a horizontal stored position to a vertical working position. In this position the blade 207 will be moved directly onto and through the safety belt. A groove or indent 206 may be placed in the base pate 201. This groove 206 allows the blade 207 to enter slightly below the base plate and ensure that the safety belt 101 will be cut.

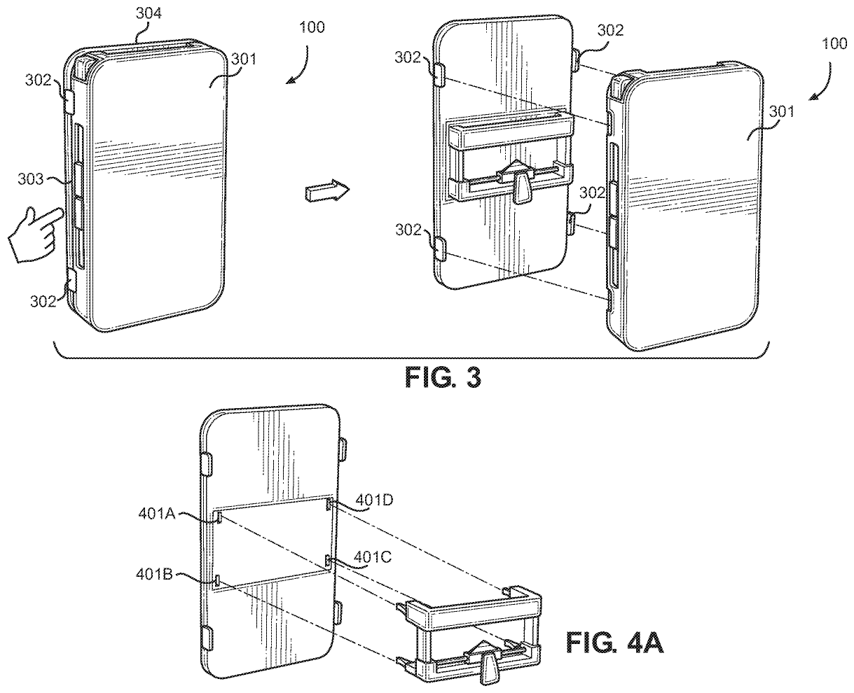

Referring now to FIG. 3 an embodiment of the safety device 100 is shown with the cover 301 attached. The cover is attached using pressure clips 302 these clips can be slightly bent to clip into place. A release button 303 is attached to the cover. The button 303 will release the pressure clips when pushed. In the present embodiment it is shown that there is an opening 304 in the cover to allow the strap to enter the device.

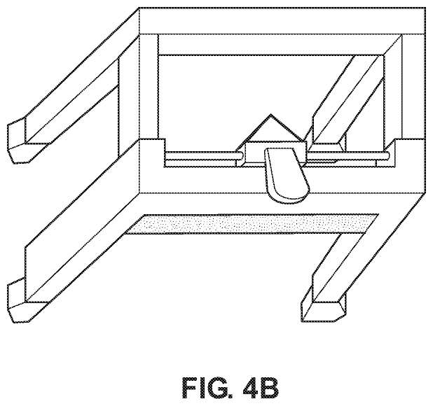

Referring now to FIG. 4A, a bottom up view of the safety device is shown. There can be seen clips 401a, 401b, 401c, 401d, all protruding through the base plate 201 of the safety device. These clips hold the blade structure 202 to the base plate 201. This will allow for the blade structure 202 to be removed and for the safety strap to be placed against the base plate and under the blade structure 202. Using this design, the blade structure will be secured to the base plate in at least four places. This will allow for a stronger connection rather than if the blade structure is only secured in two places with a gap to allow the safety strap to slide under the blade structure 202 and into place.

Referring now to FIG. 4B, a side view of the blade structure 202 is shown. In this view legs can be seen 411a, 411b, 411c, 411d, each leg has a pressure clip on the bottom to secure the blade structure 202 to the base plate 201. Further, there can be seen a soft rubber plate 412 located on the underside of the blade structure. This soft rubber is used to allow the device to be securely attached to the safety belt. In this way the safety device can grip the safety belt and not slide freely. This rubber can be configured such that it only applies enough pressure to hold the device in place but can still allow the device to slide. In other embodiments this rubber can be configured to not allow the device to slide along the safety belt. This will allow the user to know exactly where the device is after an accident.

In an embodiment there can be extended portions 413a, 413b that are attached to the legs 414a and 414b. These extended portions can be used to ensure that the safety strap remains in a position that will allow the blade to cut all the way through the belt. These extended portions may sit flush with the base plate 201 when the blade structure 202 is attached to the base plate 201. This will ensure that the safety belt does not slide under the extended portions. While the portions are only shown on two legs, they can be placed on all for legs to better help keep the safety belt in place.

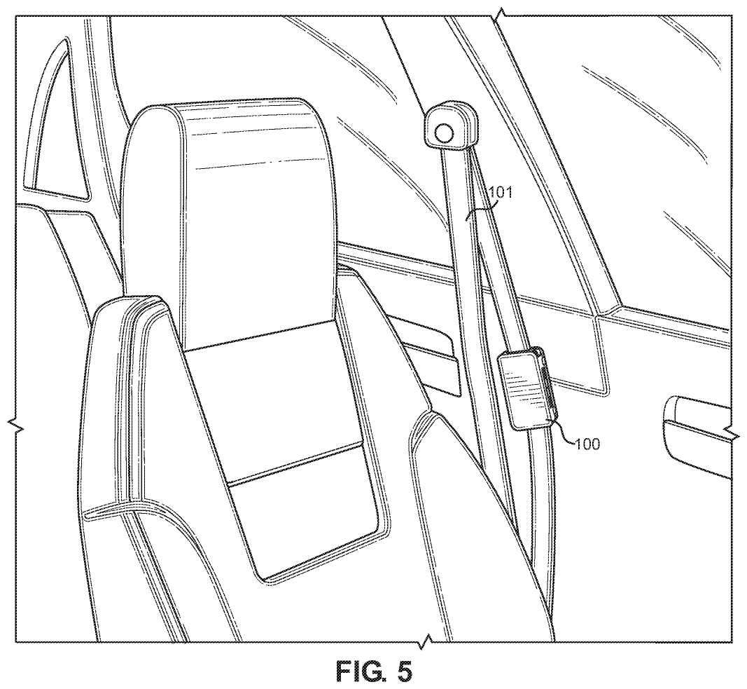

Referring to FIG. 5 an embodiment is shown where the safety device 100 is attached to a car seat belt strap 101. In this embodiment the device is attached to a vehicle safety belt against the beam of a vehicle. In this way the device remains out of the user's way. This can also prevent the user from having the device across their chest causing discomfort.

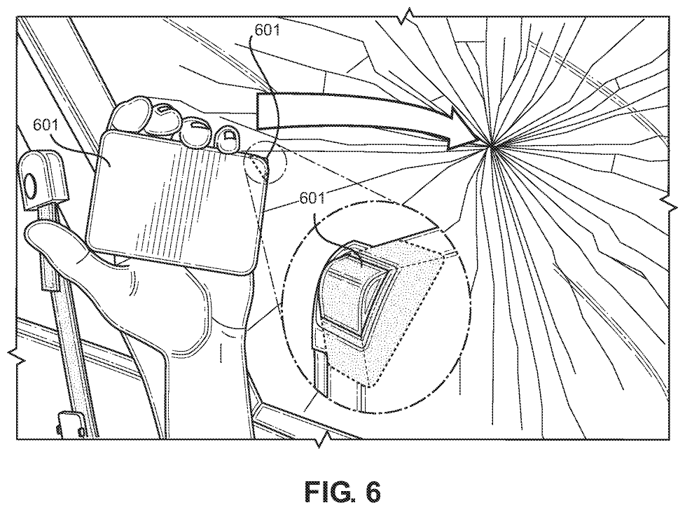

Referring to FIG. 6, an embodiment of the cover 301 is shown where a glass breaker 601 is attached to a corner of the device. While it is shown that the glass breaker 601 is attached to the corner any placement on the outside of the device is foreseeable as part of this disclosure. In this embodiment the glass breaker 601 is a slightly rounded device however, the glass breaker can be a sharper implement. The glass breaker 601 can have a secondary cover to protect a user of the safety strap from injury.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A safety device for cutting a strap, comprising:
a housing with a base plate removably affixed to a cover, wherein the housing is configured to receive the strap therethrough;
a blade structure affixed to the base plate, such that the blade bar extends a length of the base plate;
a blade slidably affixed to the blade bar, wherein the blade is configured to cut the strap when the blade is slid across a length of the blade bar.

2. The safety device of claim 1, wherein the blade structure is removably affixed to the base plate.

3. The safety device of claim 1, further comprising a glass breaker affixed to an outside edge of the cover.

4. The safety device of claim 1, wherein the blade is a flip out blade.

5. The safety device of claim 1, wherein the blade is a push out blade.

6. The safety device of claim 1, wherein the base plate and blade structure are configured to allow the device to slide over the strap while still being attached.

7. The safety device of claim 1, wherein the cover is configured to allow the strap to freely move between the cover and the base plate when the cover is attached.
